(19) United States
(12) Patent Application Publication
(10) Pub. No.: US 2015/0273676 A1
(43) Pub. Date: Oct. 1, 2015

(54) OPTIMIZED PNEUMATIC HAMMER

(71) Applicant: Michael B. Spektor, Portland, OR (US)

(72) Inventor: Michael B. Spektor, Portland, OR (US)

(21) Appl. No.: 14/227,403

(22) Filed: Mar. 27, 2014

(51) Int. Cl. B25D 9/16; B25D 9/04

(52) U.S. Cl. CPC B25D 9/16; B25D 9/04

(57) ABSTRACT

The optimized pneumatic hammer is characterized by maximum performance efficiency that is achieved due to author's analytical investigations which revealed the existence of the optimal value of the striker's length with respect to maximum kinetic energy of the tool. On the contrary to the existing hammers, in the optimized hammers the length of the strikers is shorter than their strokes. Calculations based on the mentioned investigation show that the kinetic energy of optimized hammers could be about 2.5 times higher than of their existing counterparts. The optimized pneumatic hammer has two modes of operation—the regular mode of operation during which the tool interacts with the target media and the retracting mode of operation for releasing the severely jammed tool from the media. Optimized pneumatic hammers allow for a considerable decrease of their weight and diameters without compromising their performance while making easier the work of the operators.

### FIELD OF THE INVENTION

The present invention belongs to the group of pneumatically operated impact machines used in construction, mining, and other industries. During the operation these machines can be handled manually or by a mechanical arm.

### BACKGROUND OF THE INVENTION

Pneumatic hammers are known and widely used for a long time. A considerable amount of US patents reflects the plurality of structures and design features of these hammers. The U.S. Pat. No. 513,941 issued in 1894 and U.S. Pat. No. 813,109A issued in 1906 represent examples of early designs of pneumatic hammers. The U.S. Pat. No. 5,419,403 issued in 1993 and U.S. Pat. No. 6,192,997 issued in 2001 represent some examples of later designs of these hammers. In spite of the significant variety of pneumatic hammers, all of them comprise the following basic units and components: a tubular housing, an air distributing mechanism, a striker (piston), a tool holder, and a tool (chisel, compactor, etc.). The main components of the air distributing mechanism are located inside of the rear end of the tubular housing or attached to it. Under the action of compressed air, the striker reciprocates inside of the tubular housing. The tool holder is rigidly attached to the front end of the tubular housing and it is movably accommodating the tool. During the operation of the pneumatic hammer, the striker cyclically performs forward and backward strokes. At the end of its forward stroke the striker imparts a blow to the tool transferring to it a certain amount of kinetic energy and enabling the tool to interact with the target medium. It should be emphasized that normally the tubular housing is not subjected to blows of the striker at the end of its forward strokes. The motion of the striker during its backward stroke is usually slowed down by a pneumatic cushion in order to minimize or prevent the blows of the striker to the internal components that are located in the rear part of the tubular housing. The productivity rate or the efficiency of a pneumatic hammer is reflected by the measure of distortion or deformation of the target medium during a single cycle. The distortion or deformation of the medium is proportional to the amount of kinetic energy that the tool cyclically obtains as a result of the striker's blows. Thus, the performance of a pneumatic hammer is characterized by the amount of kinetic energy that the tool is cyclically receiving during the working process. The kinetic energy of the tool depends on the amount of kinetic energy of the striker before the impact (the impact energy of the striker) and on the degree of energy transfer from the striker to the tool in the process of the collision. The kinetic energy of the striker equals to the product of multiplying of the compressed air pressure force applied to the striker by the length of its stroke. The air pressure force depends on the nominal air pressure of the source of compressed air and the diameter of the striker (or internal diameter of the tubular housing). Normally, the nominal pressure of the compressed air is predetermined by industrial norms and represents a given factor for the pneumatic hammers. The diameter or cross-sectional area of the striker, its length, and the length of the stroke are variable parameters that are assigned during the development and design processes according to certain design considerations. The sum of the length of the striker and its stroke represents a part of the length of the tubular housing and represents the effective length of the tubular housing. In each pneumatic hammer the sum of the lengths of the striker and its stroke has a certain value. Actually, the striker reciprocates in the limits of the effective length of the tubular housing. When the internal diameter of the tubular housing and its effective length are predetermined, it is possible to control the amount of the kinetic energy of the striker before the collision (the impact energy) just by changing the length of the striker. So, the shorter the striker the longer is its stroke and consequently, the higher is its impact energy (and vice versa). The degree of energy transfer from the striker to the tool is proportional to the mass ratio between the striker and the tool. So, a shorter striker has a smaller mass that resulting in a lower degree of energy transfer from the striker to the tool. The ultimate goal of the development of a pneumatic hammer is to achieve the possible maximum kinetic energy of the tool. This goal is achievable if it could be determined such a value of the length of the striker and, consequently, of its stroke that would result in the maximum energy of the tool. This is a problem of optimization that requires an appropriate analytical approach to the dynamics of the working process of the hammer.

The author of the current invention carried out the analytical investigation that is focused on determining the optimal value of the length of the striker and its stroke with respect to maximum value of the kinetic energy that the tool obtains as a result of the impact of the striker. This investigation revealed the existence of the optimal values of the striker and its stroke with respect to maximum energy of the tool. Based on this investigation, the mathematical formulas for calculating the optimal values of the length of the striker and its stroke are derived. These optimal values basically depend on the geometric characteristics of the tubular housing, the striker, and the tool. This investigation and its results are not published, however they are available from the author by demand. The existence of the optimal values of the lengths of the striker and its stroke that cause the possible highest performance efficiency of the pneumatic hammer were unknown. And, consequently, there were no objective criteria to evaluate the performance efficiency of a hammer. The comparison of the actual length of the striker and its stroke of a hammer with the calculated optimal values of these parameters provides an objective evaluation of the efficiency of this hammer. The analysis of these formulas shows that the optimal length of the striker is considerably less than 50% of the effective length of the tubular housing, while the optimal length of the stroke considerably exceeds 50% of the mentioned effective length. Thus, the optimal length of the stroke is longer than the optimal length of the striker. The length of the striker in the existing pneumatic hammers is essentially longer than 50% of the effective length of the tubular housing and is considerably longer than the length of its stroke. Usually, in the existing hammers the stroke is much less than 50% of the effective length of the tubular housing. The carried out by the author analytical investigations show that the values of the basic parameters of all existing pneumatic hammers considerably differ from the appropriate optimal values. This is causing a significant deficiency in the performance of the existing pneumatic hammers. Appropriate calculations show that for the existing pneumatic hammers the amount of kinetic energy of their tools is about 2.5 times less than the possible maximum value of kinetic energy if the same hammers would have the optimal values of their parameters. It should be emphasized that if an optimized hammer and an existing hammer would have the same kinetic energy of their tools, the optimized hammer would have a significantly reduced diameter of the striker. As a result of this the weight of the optimized hammer would be essentially smaller and the upward compressed air force, that the operator should overcome during each forward stroke of the striker, would be significantly reduced. All this indicates that the optimization of pneumatic hammers has many positive outcomes.

The optimization of the existing pneumatic hammers cannot be achieved by simply reassigning the lengths of their strikers and their strokes. As it is mentioned above, in the vast majority, if not all, of the existing pneumatic hammers the length of the stroke is significantly shorter than the length of the striker. The vast majority of the existing air distributing mechanisms imposes limits on the increase of the stroke of the striker. In addition to this, as it was mentioned above, in an optimized hammer the length of the striker is considerably less than the length of its stroke. This also makes it impossible to optimize the existing hammers without appropriate structural changes. This can be illustrated by considering the following hypothetical example where the striker is shorter than the stroke. Usually, during the forward stroke, the striker overlaps the radial exhaust passage in the tubular housing. However, at the end of the forward stroke before imparting a blow, the striker passes this passage, and does not overlap it for a very short instance. So, this passage becomes open to the atmosphere letting the compressed air to escape. Immediately after imparting the blow to the tool the striker begins its backward stroke, being forced by the compressed air that is redirected to the front end of the striker by the air distributing mechanism. The striker starts to move backward and again overlaps the exhaust passage. If the striker is shorter than the stroke, this passage will become open to the atmosphere as soon as the striker will pass it during its backward stroke. Since the striker is shorter than the stroke, this will happen much before than the striker will approach to the end of its backward stroke. The compressed air will escape to the atmosphere before the backward stroke is completed, and, as a result of this, the operation of the hammer will be terminated.

In comparison with other air distributing mechanisms that support limited strokes of the striker, the U.S. Pat. No. 7,273,113 B2, issued on Sep. 25, 2007 to the author of the current application, presents a soil penetrating impact machine with an air distributing mechanism that supports practically unlimited strokes of the striker. A hammer with this kind of an air distributing mechanism is suitable for optimization. However, this air distributing mechanism also has the same problem associated with the early opening of the exhaust passage during the backward stroke in case when the striker is shorter than the stroke and, consequently, the backward stroke could not be completed.

Thus, in order to optimize the parameters of the pneumatic hammers with respect to maximum kinetic energy of their tools it is necessary to develop completely new pneumatically operated impact machines. A possible embodiment of an optimized hammer is presented in the current application.

In the light of the proposed optimization, it becomes clear that the efficiency of the performance of the existing pneumatic hammers is very low in comparison with the achievable efficiency of the same hammers if their parameters would be optimized. This represents a severe disadvantage of the existing pneumatic hammers.

The other disadvantage of existing pneumatic hammers is associated with ergonomic aspects of their operation. One of these disadvantages is the heavy weight of the pneumatic hammers causing physical difficulties to the operators. In cases of using the hammers to destroy asphalt or concrete the operator has to reposition the hammer from point to point several times in a very short period of time. Each time the hammer should be lifted and moved to a new position. When the operator tries to lift the hammer, the compressed air supply to the hammer is automatically cut off and the operator continues to apply a physical effort that should overcome the weight of the hammer and the resistance of the jammed tool in the distorted medium.

The next disadvantage is related to the need of overcoming by the operator the air pressure force that tends to push up the hammer during the forward stroke of the striker. The operator can apply to the hammer just a part of his or her weight that is usually insufficient to prevent the hammer from its upward motion during the forward stroke of the striker. As a result of this the actual length of the displacement of the striker during its forward stroke becomes equal to the difference between the length of the full stroke and the length of the displacement of the tubular housing. Thus, the striker performs a reduced stroke and gains a decreased amount of kinetic energy. In addition to this, during the forward stroke of the striker the tool moves upward together with the tubular housing and is gaining a certain amount of upward velocity before the impact. As a result of all of this the tool obtains a decreased amount of kinetic after the impact. Also it is important to emphasize that the physical stress associated with the need to overcome the air pressure force, that is lifting the hammer, is tiresome for the operator. One more disadvantage is associated with the difficulties of releasing the tool from a severe jam by the distorted medium. It becomes stressful and frustrating to release the tool from this kind of a jam.

The current invention offers an optimized pneumatic hammer that is free from all these disadvantages.

### SUMMARY OF THE INVENTION

This invention represents an optimized pneumatic hammer that is characterized by maximum kinetic energy of its tool.

The author of the current invention carried out an analytical investigation of the dynamics of the motion of the striker during its forward stroke including the interaction between the striker and the tool at their collision. The goal of this investigation was to determine the optimal values of the length of the striker and its stroke with respect to maximum value of kinetic energy that could be obtained by the tool as a result of the impact. This investigation revealed the existence of the optimal values of the length of the striker and its stroke at which the tool receives the maximum kinetic energy as a result of the striker's blow. Based on this investigation, the mathematical formulas for calculating the optimal values of the striker and its stroke are derived. These formulas include the following parameters of a pneumatic hammer: the part of the length of the tubular housing in which the striker reciprocates (the effective length of the tubular housing), the diameters of the striker and the tool, and the length of the tool. These formulas allow calculating the optimal values of the parameters for any pneumatic hammer. The optimal length of the striker and the optimal length of its stroke are interrelated values since the sum of these two lengths equals to the effective length of the tubular housing. The analysis of the above mentioned formulas indicates that the optimal value of the striker's length is always less than the half of the effective length of the tubular housing, and, consequently, the optimal length of the stroke always exceeds the half of the mentioned effective length. Actually, calculations based on some realistic values of the parameters of the pneumatic hammers and their tools show that the optimal values of the length of the striker are closer to about 25% while the optimal values of the stroke are closer to about 75% of the effective length of the tubular housing.

The existence of the optimal values of the considered parameters of the hammers was not known, and there were no objective criteria to evaluate the performance of the hammers. The results of the analytical investigation of the hammers allow comparing the efficiency of the existing pneumatic hammers with the achievable efficiency of their optimized counterparts. The appropriate calculations show that the amount of the kinetic energy that the tool could obtain due to the optimization is about 2.5 times higher than in an existing pneumatic hammer having the same basic parameters such as the effective length of the tubular housing, its inside diameter, and having the same tool. The significant increase in the efficiency of pneumatic hammers may open new beneficial directions in the development and application of pneumatically operated hammers.

The existing pneumatic hammers, as it was explained above, cannot be optimized by reassigning of the lengths of their strikers and strokes. The optimization of pneumatic hammers can be achieved by development appropriate new systems. The invention offers a possible embodiment of an optimized pneumatic hammer that is characterized by the maximum kinetic energy of its tool.

Another aspect of the invention is that the optimized pneumatic hammer is capable to work in two modes of operation: in the regular and in the retracting modes of operation. During the regular mode of operation the striker imparts blows to the tool enabling the tool to interact with the target medium. The retracting mode of operation is used in case of a severe jam of the tool. During this mode of operation the striker at the end of its forward stroke does not touch the tool while at the end of its backward stroke the striker is imparting a blow to a rear internal component that is rigidly secured to the tubular housing. The retracting mode of operation is very helpful when it is needed to release the severely jammed tool from the target medium.

The next aspect of the invention is associated with the possibility of decreasing the weight of the hammer by reducing the inside diameter of the tubular body which in the same time will reduce the upward air pressure force that the operator should overcome during the forward stroke of the striker in regular mode of operation. This possibility is based on the high level of kinetic energy of the optimized pneumatic hammers. An optimized hammer that provides the tool with the same amount of kinetic energy as the existing hammer will have a smaller inside diameter of the tubular housing and its length will be shorter. All this will result in decreasing of the weight of the hammer and in the same time in reducing of the upward air pressure force that will make the working process less tiresome for the operator.

It should be mentioned that the hammer according to this invention does not have an automatically operating shut off valve that interrupts the compressed air supply when the operator tries to lift and reposition the hammer. If the hammer would continue to operate during its repositioning, the upward pressure force would help to lift the hammer and to release the tool from light jams. Obviously, that this is easily achievable in the existing hammers. It may be assumed that the spring loaded shut off valves were incorporated in the existing manually handled pneumatic hammers in order to save some compressed air when the operator is lifting the hammer for repositioning. And it is very possible that historically the first hammers did not have this spring loaded shut off valve. And it seems to be justifiable to spend some compressed air in order to help the operator to reposition the hammer.

All these aspects of the invention will become apparent from the detailed description of the illustrated embodiment.

### BRIEF DESCRIPTION OF THE DRAWING

FIG. 1 represents a partial front view of an optimized pneumatic hammer (handles for the operator or an attachment for a mechanical arm are not shown).

FIG. 2 represents a partial left side view of an optimized pneumatic hammer.

FIGS. 3A, 3B, and 3C of which FIG. 3B is a continuation of FIG. 3A, and FIG. 3C is a continuation of FIG. 3B represent a longitudinal sectional view of an optimized pneumatic hammer taken along the line 1-1 in the FIG. 1. These FIGS. (3A, 3B, and 3C) are recommended for the front page of the patent.

FIG. 4 is a cross-sectional view taken along the line 2-2 in the FIG. 3A.

FIG. 5 is a cross-sectional view taken along the line 3-3 in the FIG. 3A.

FIG. 6 is a revolved partial longitudinal sectional view taken along the line 4-4 in the FIG. 4. In this view the air control valve 132 is shown in its extreme rear (left) position.

FIG. 7 is a revolved partial longitudinal sectional view taken along the line 4-4 in the FIG. 4 and is similar to the view in FIG. 6 except that the air control valve (132) is shown in its extreme right (front) position.

FIG. 8 is presenting the mathematical formula for calculating the optimal value of the length of the striker.

FIG. 9 is presenting the mathematical formula for calculating the optimal value of the length of the forward stroke of the striker.

### DESCRIPTION OF THE ILLUSTRATED EMBODIMENT

### General Description

A pneumatic hammer can be handled by a mechanical arm or by handles and can operate in vertical, horizontal, and inclined positions. All this does not have any influence on the structure of the optimized pneumatic hammer offered in the current patent application. This is the reason why the proposed embodiment is shown in the horizontal position and without handles or an attachment for a mechanical arm.

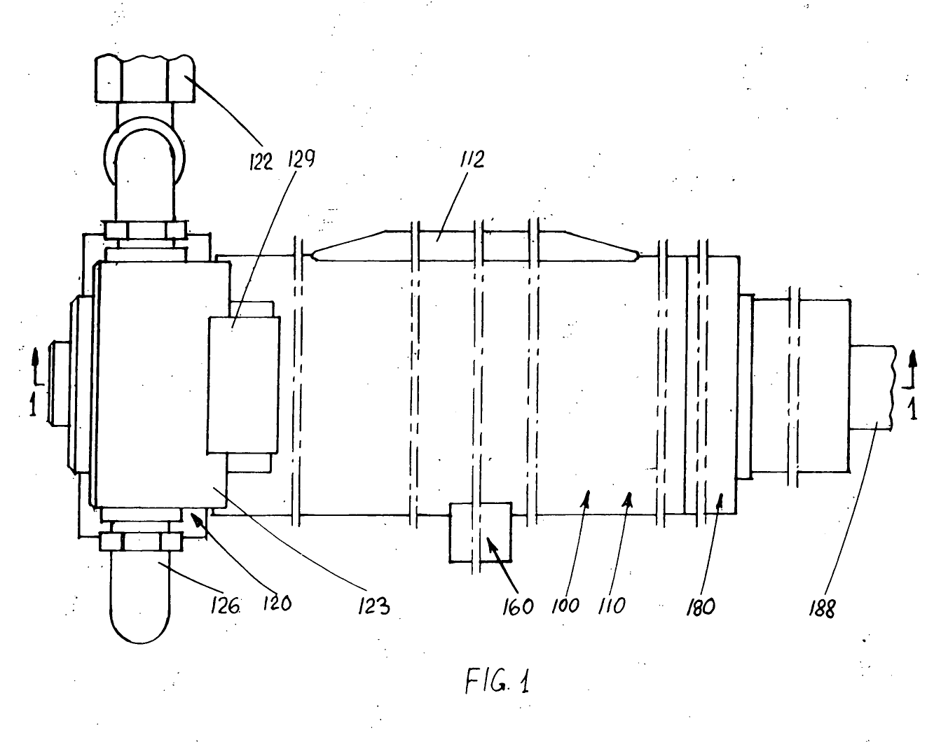

FIGS. 1, 2, 3A, 3B, and 3C show an optimized pneumatic hammer 100 comprising, according to the invention as basic assemblies, a tubular housing assembly 110, a compressed air flow splitter assembly 120, an air control valve chest assembly 130, a striker assembly 150, a tool holder assembly 180, and an exhaust control assembly 160.

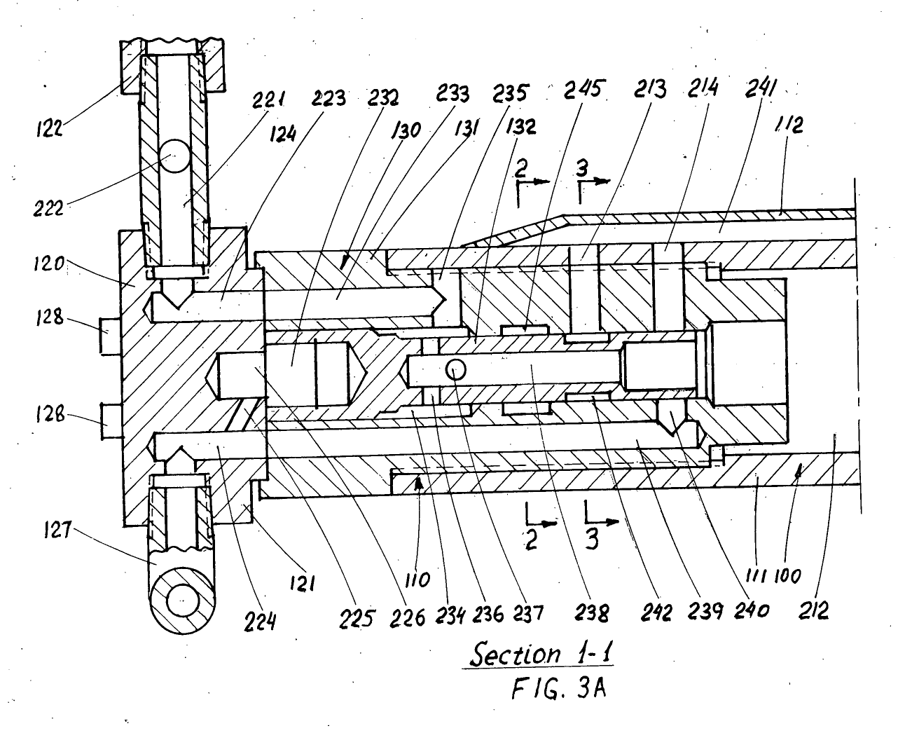

Tubular housing assembly 110 is comprising a tubular housing 111, a longitudinal air conduit 112, and means (not shown) for handling the hammer by the operator or by the mechanical arm. Compressed air flow splitter assembly 120 is comprising a splitter body (splitter) 121, a switching valve 122, an air pressure regulator 123 with a pressure gauge 141, fittings 124, 125, 126, and 127, an air hose 129, and a group of bolts 128. Switching valve 122 with one of its ends is secured to fitting 124 and with the other end (not shown) by means of a quick connector to an air hose that is connected to the source of compressed air. Air control valve chest assembly 130 is comprising a control valve chest 131 and double stepped air control valve (air control valve) 132. As shown in the FIG. 3B, striker assembly 150 is comprising a striker body (striker) 151, a pair of bushings 152 and 153, and a pair of retaining rings 154 and 155. Bushings 152 and 153 are made of low friction materials. As an alternative design solution, bushings 152 and 153 could be built up on striker 151 by using bronze welding electrodes. After welding, the bushings should be machined to the required specifications. In this case retaining rings 154 and 155 are not needed. As shown in FIG. 3C, tool holder assembly 180 is comprising a tool holder housing 181, a leading bushing 182, a conventional hammer tool (tool) 183, a coil spring 184, a spring holding sleeve 185, and a washer 189. FIG. 3B shows exhaust control assembly 160 comprising an exhaust valve chest 161, an exhaust valve 163, a plug 164, and a set screw 162.

The assembly process of the optimized pneumatic hammer may be accomplished in the following steps. Control valve chest 131 should be securely screwed into the rear (left) end of tubular housing 111 and thread-locking means should be applied. After that, radial holes 213, 214, and 268 should be drilled in tubular housing 111 along one line. In the next setup, tubular housing 111 should be rotated a half of a turn and radial holes 261 and 266 should be drilled. Then the nest should be milled in the wall of tubular housing 111 for accommodating exhaust valve chest 161 that should be rigidly secured to tubular housing 111. After that, longitudinal conduit 112 that represents an angular structural shape, should be rigidly attached to the lateral surface of tubular housing 111 creating an air passage 241 that connects radial holes 213, 214, and 268.

After that, striker assembly 150 should be put together and inserted into tubular housing 111 from its front (right) end. Then air control valve 132 is inserted into air control valve chest 131. A threaded bar partially screwed into threaded hole 232 of air control valve 132 can be used to assist the assembly. The next step is connecting air pressure regulator 123 with pressure gauge 141 to splitter 121 using fittings 124, 125, 126, 127, and air hose 129. Then switching valve 122 should be secured to fitting 124. After that, splitter 121 should be secured by means of bolts 128 to the rear end of air control valve chest 131. The next step is completing exhaust control assembly 160 by inserting exhaust valve 163 into exhaust valve chest 161 and by pressing into exhaust control chest 161 plug 164 and then securing it with set screw 162. The next step is pressing leading bushing 182 into tool holder housing 181 that should be secured to the right (front) end of tubular housing 111 by means of a threading connection. And then the rear (left) part of tool 183 (the shank) is inserted into leading bushing 182, after that washer 189 and coil spring 184 are put on tool 183. The last step of the assembly is to screw in spring holding sleeve 185 into tool holder housing 181. In order to prevent self loosening of spring holder sleeve 185, some conventional means such as set screws and other could be used (not shown in the drawing).

### A. Operation of the Optimized Pneumatic Hammer

The air distributing system of the present invention comprises two separate lines of compressed air that differ by the level of the air pressure in these lines. These lines receive compressed air simultaneously from the same source of compressed air; however one line is directly connected to the source of compressed air and, consequently, is pressurized by the nominal (high) pressure, while the other line receives the compressed air through an air pressure regulator that reduces the nominal (high) pressure to a lower level. The compressed air at the nominal (high) pressure is cyclically applied to the left (rear) end of striker assembly 150 for performing its forward stroke, while the compressed air at the reduced (low) pressure is cyclically applied to the right (front) end of striker assembly 150 for performing its backward stroke.

According to the current invention, optimized pneumatic hammer 100 is designed to work in two modes of operation: the regular and the retracting modes of operation. The regular mode of operation represents the conventional hammer's working process that is characterized by the interaction between its tool 183 and the target medium. The retracting mode of operation is used in case when tool 183 is severely jammed in the medium. By appropriate adjustments of the pressure in the reduced (low) pressure line, optimized pneumatic hammer 100 is set to the desired mode of operation. The value of the nominal (high) pressure of industrial compressors is 100-110 psi. By adjusting the air pressure in the reduced (low) pressure line to about 25-35 psi, optimized pneumatic hammer 100 will work in the regular mode of operation; while by adjusting the pressure in this line to about 60-80 psi, this hammer will work in the retracting mode of operation. It should be noted that the mentioned above levels of air pressure for these two modes of operation are approximate, and in each case the operator by applying fine tuning to air pressure regulator 123 will achieve the desired performance of the hammer. The adjustments of the pressure in the reduced (low) pressure line by adjusting knob 291 of air pressure regulator 123 take just a few seconds and can be done while the hammer is working or not. There are no limits on switching over from one mode operation to another.

### A.1. Regular Mode of Operation

During the regular mode of operation the air pressure in the reduced (low) pressure line is adjusted by the operator to the required level. In this mode of operation striker assembly 150 is cyclically imparting blows to tool 183 that interacts with the target medium. The motion of striker assembly 150 during its backward stroke is restricted by an air cushion in order to minimize or prevent the impact to the rear (left) internal component that is rigidly secured to e tubular housing 111.

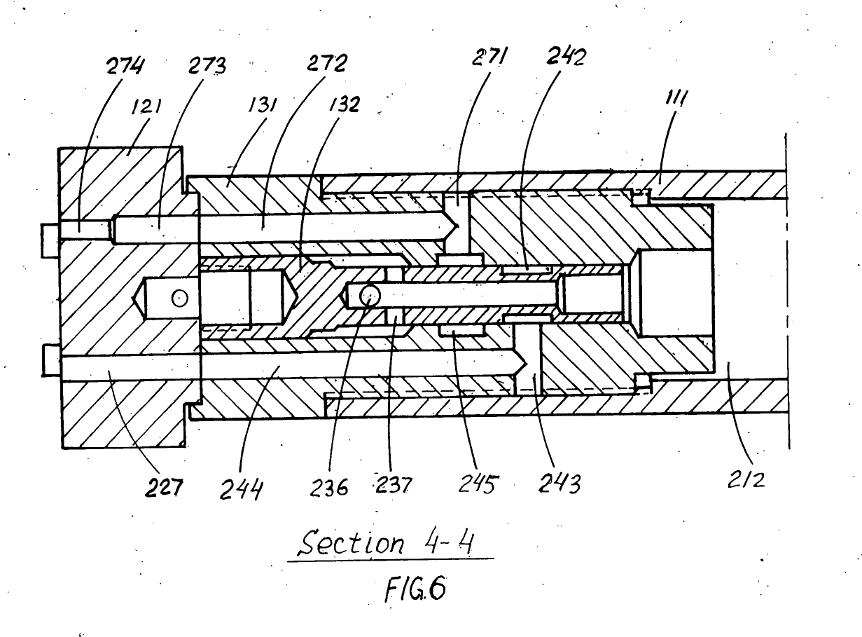

Let us consider the basic principles of the functioning of the air distributing mechanism during the regular mode of operation. The compressed air through relatively small cross-sectional area ducts enters into a cylindrical space inside tubular housing 111 behind striker assembly 150 that has a relatively large cross-sectional area. This space represents rear chamber 212 (FIG. 3A) that is limited on the left (rear) by the right (front) forehead of air control valve chest (131), while the limit on the right (front) is presented by the left (rear) end of striker assembly 150. The volume of rear chamber 212 is changing in accordance with the displacement of striker assembly 150. The cylindrical space inside tubular housing 111 between the right (front) end of striker assembly 150 and the left (rear) end of tool 183 represents front chamber 251 (FIGS. 3B and 3C), that also has a changing volume. This chamber during the forward stroke of striker assembly 150 is open to the atmosphere. At the beginning of the forward stroke the air pressure in rear chamber 212 is the same as in the nominal (high) pressure line. However, due to the accelerated motion of striker assembly 150, the volume of rear chamber 212 is increasing while the supply of the compressed air through the small ducts cannot catch up with the rate of the increase of this volume. As a result of this the pressure in rear chamber 212 is gradually decreasing. However, at the end of the forward stroke of striker assembly 150 the pressure in rear chamber 212 considerably exceeds the pressure in the reduced (low) pressure line. When striker assembly 150 is very close to the end of its forward stroke, exhaust passage 261 (FIG. 3B) becomes open to the atmosphere, the pressure in rear chamber 212 abruptly drops, and air control valve 132 under the reduced (low) pressure is forced to move to its extreme right (front) position (FIG. 7). In this position of air control valve 132, rear chamber 212 becomes open to the atmosphere and the reduced (low) pressure line begins to supply compressed air into front chamber 251 forcing striker assembly 150 to begin its backward stroke. The detailed description of the regular mode of operation is presented below.

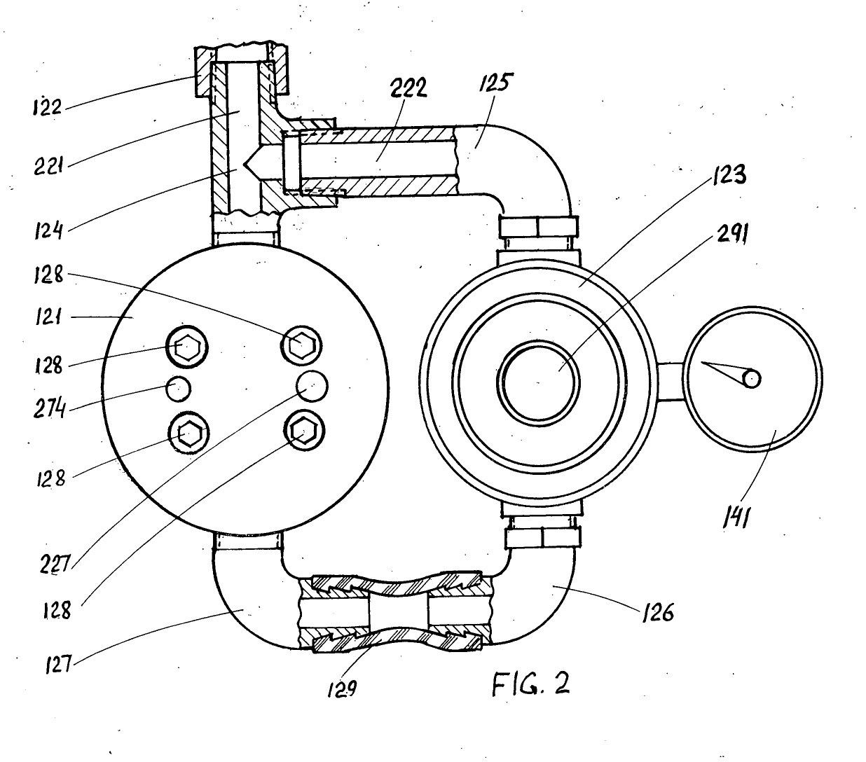

As it is seen from FIGS. 1, 2, and 3A, when switching valve 122 becomes open, the compressed air at the nominal (high) pressure flows through passage 221 into duct 223 in splitter 121 and from there through longitudinal passage 233 and radial duct 235 in air control valve chest 131 into ring space 234 that is always communicating with radial duct 235 regardless of the position of air control valve 132. The continuation of the air flow at nominal (high) pressure is considered below. At the same time, the compressed air at nominal (high) pressure through passage 222 (FIG. 2) enters into air pressure regulator 123 whereby help of adjusting knob 291 and pressure gauge 129 the air pressure is reduced to the required level, and after that the air flow at the reduced (low} pressure enters through the passage in fitting 126, air hose 141, and the passage in fitting 127 into duct 224 in splitter 121, and from there into longitudinal hole 239 and radial duct 240 in air control valve chest 131, and in the same time through inclined duct 225 into cavity 226 in splitter 121 and cavity 233 in air control valve 132.

Thus, when switching valve 122 becomes open, the compressed air at nominal (high) pressure enters into ring space 234 constantly pushing air control valve 132 to the left (rear) while in the same time the compressed air at reduced (low) pressure enters into cavity 232 and is constantly pushing this valve to the right (front). Since the positions of movable components of optimized pneumatic hammer 100 before the opening of switching valve 122 are unpredictable, we have to consider the possible options of interaction of the movable components with the air flows before the normal working process begins. Assume that striker assembly 150 is at the end of its forward stroke. This is the only case when exhaust passage 261 could become open to the atmosphere (this will be explained below). In this case, the air pressure in rear chamber 212 abruptly drops and air control valve 132 under the action of the compressed air at the reduced (low) pressure in cavity 232 moves to its extreme right (front) position, practically without any resistance, since the nominal (high) pressure line is connected to the atmosphere through rear chamber 212 and exhaust passage 261. When air control valve 132 is in its extreme right (front) position and rear chamber 212 is open to the atmosphere, the compressed air at reduced (low) pressure enters into front chamber 251 initiating a normal backward stroke of striker assembly 150, and the working process starts. We considered a situation where striker assembly 150 is at the end of its forward stroke causing rear chamber 212 to communicate with the atmosphere. In all other positions of striker assembly 150, rear chamber 212 is not open to the atmosphere and the air pressure inside of this chamber is considerably higher than in the reduced (low) pressure line. As a result of this, the air pressure force pushing air control valve 132 to the left (rear) considerably exceeds the air pressure force at the reduced (low) pressure that constantly pushes this valve to the right (front). So, air control valve 132 moves to its extreme left (rear) position. In this case, front chamber 251 becomes open to the atmosphere, while striker assembly 150 under the air pressure in rear chamber 212 is forced to complete its forward stroke, and the working process starts. A detailed description of the air flows for the considered situations is presented below. Thus, regardless of the positions of the movable components of the hammer, the working process will start upon opening of switching valve 122.

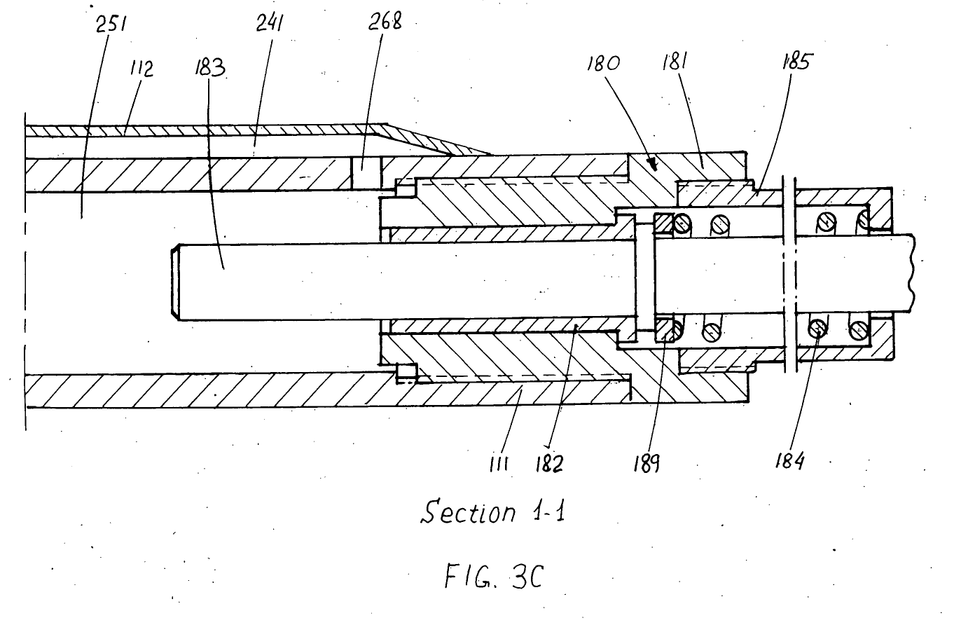

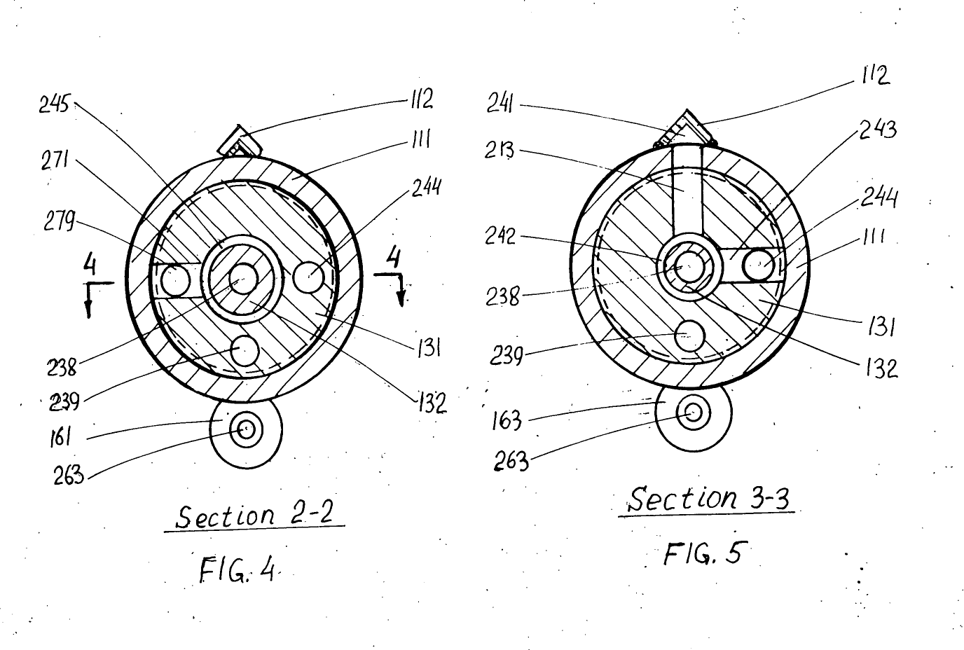

Let us consider a cycle of the working process of optimized pneumatic hammer 100 for the case where air control valve 132 is in its extreme left (rear) position, as it is shown in FIG. 3A. We already traced the flow of the compressed air at nominal (high) pressure to ring space 234, and the flow of the compressed air at the reduced (low) pressure to radial duct 240, where this flow stops since air control valve 132 overlaps radial duct 240. The compressed air at nominal (high) pressure continues to flow from ring space 234 trough radial holes 236 and 237 into central hole 238 in air control valve 132, and from there into rear chamber 212 forcing striker assembly 150 to perform its forward stroke. At this time, front chamber 251 is open to the atmosphere through radial hole 268 (FIG. 3C) in the wall of tubular housing 111, longitudinal passage 241, radial passage 213, grove space 242, radial duct 244, and longitudinal holes 244 and 227 (FIGS. 3A, 5, and 6). Since front chamber 251 during the forward stroke is connected to the atmosphere, the air resistance to the motion of striker assembly 150 is not essential. However, due to the accelerated motion of striker assembly 150 during its forward stroke, front chamber 251 becomes slightly pressurized. Besides escaping to the atmosphere, the pressurized air from front chamber can enter into exhaust passage 261 and from there into ring space 262 and also into cavity 265 in exhaust valve chest 161 through radial duct 266 (FIG. 3B). As a result of this, exhaust valve 163 will be subjected to the action of two oppositely directed air pressure forces. Since the air pressure pushing exhaust valve 163 to the left is applied to a bigger cross-sectional area than the air pressure pushing this valve to the right, exhaust valve 163 will be moved to its extreme left position, as it is shown in FIG. 3B, and the exhaust passage 261 will be blocked. During the continuation of the forward stroke, striker assembly 150 will overlap exhaust passage 261, however at the end of the forward stroke before imparting a blow to tool 183, bushing 152, as it is shown in FIG. 3B, will be to the right of exhaust passage 261 and the overlapping of this passage ended, while this passage becomes open to the air flow from rear chamber 212. During the forward stroke due to the rapidly accelerated motion of striker assembly 150, the air pressure in rear chamber 212 gradually drops. The compressed air from rear chamber 212 at a pressure that is still considerably higher than the reduced (low) pressure, enters into exhaust passage 261 and from there into ring space 262 (FIG. 3B) pushing exhaust valve 163 to the right. Since cavity 265 through radial duct 266 communicates with the ring space 267 between striker 151 and tubular housing 111, there will be almost no resistance to move exhaust valve 163 to the right. In this case, rear chamber 212 becomes connected to the atmosphere through exhaust passage 261 and holes 263 and 264. The air pressure in rear chamber 212 will abruptly drop below the level of the reduced (low) pressure and air control valve 132 under the action of the reduced (low) air pressure in cavity 232 will move to its extreme right (front) position, as it is shown in the FIG. 7. Almost at the same time striker assembly 150 will impart a blow to tool 183. The compressed air at nominal (high) pressure will be trapped in a relatively small ring space 270 (FIG. 7) that is still communicating with radial duct 235 (FIG. 3A), which is constantly pressurized by the nominal (high) line. However, since the cross-sectional area of ring space 270 is relatively very small, the air pressure forcing air control valve 132 to the left is considerably smaller than the air pressure pushing this valve to the right, and this valve will remain in its extreme right (front) position. In this case radial passage 213 is overlapped by air control valve 132, while grove space 242 is communicating with radial duct 240 and radial passage 214 allowing the air flow at reduced (low) pressure to enter into longitudinal passage 241, and from there through radial hole 268 into front chamber 251 (FIG. 3C). The compressed air at reduced (low) air pressure in front chamber 251 is forcing striker assembly 150 to begin its backward stroke. Now, since control valve 132 has moved to its extreme right (front) position, radial ducts 236 and 237 communicate with groove space 245 (FIG. 7). connecting rear chamber 212 to the atmosphere through central hole 238 in control valve 132, radial ducts 236 and 237, groove space 245, radial duct 271, longitudinal hole 272, longitudinal duct 273, and orifice 274 (FIGS. 2 and 7). Due to orifice 274 the air flow from rear chamber 212 to the atmosphere is restricted and an air cushion will be slowing down striker assembly 150 preventing it from imparting a blow to the right (front) end of air control valve chest 131. It should be mentioned that the cross-sectional area of orifice 274 can be adjusted by means, for example, of an adjustment screw (not shown). During its backward stroke, striker assembly 150 is moving to the left (rear) and when bushing 153 will pass passage 266 (FIG. 3C), compressed air at reduced (low) pressure from front chamber 251 through passage 266 will enter into cavity 265, pushing with no resistance exhaust valve 163 to its extreme left (rear) position. As a result of this, exhaust passage 261 becomes cut off from the atmosphere. During the farther motion of striker assembly 150, bushing 153 will pass exhaust passage 261 and the compressed air at the reduced (low) pressure from front chamber 251 will also enter into ring space 262 pushing exhaust valve 163 to the right. However, the cross-sectional area of ring space 262 is considerably smaller than the cross-sectional area of cavity 265, and since the air pressure on both end of exhaust valve 163 is the same, this valve will remain in its extreme left (rear) position, preventing front chamber 251 from communicating with the atmosphere during the entire backward stroke of striker assembly 150. At the end of the backward stroke striker assembly 150 with its tail part 281 pushes control valve 132 to its extreme left (rear) position, the backward stroke ends and the forward stroke begins, starting a new cycle of the regular mode of operation.

### A.2. Retracting Mode of Operation

During the retracting mode of operation the reduced (low) pressure is adjusted to about 60-80 psi. In this mode of operation striker assembly 150 does not complete a full forward stroke and does not touch tool 183, however it imparts a blow to the right (front) end of air control valve chest 131 at the end of its backward stroke.

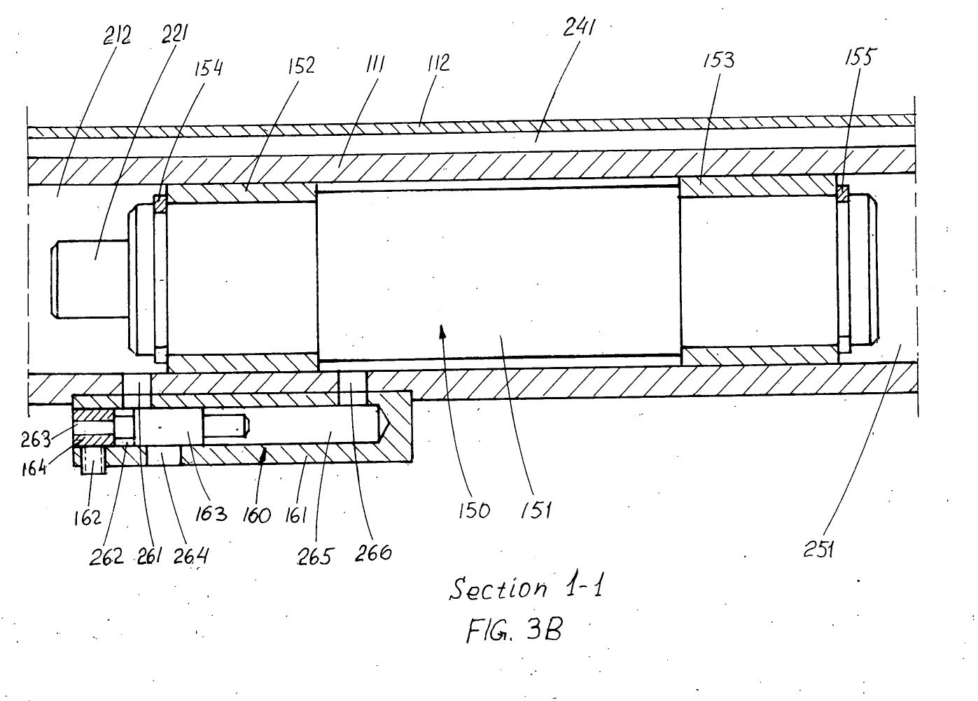

Referring to FIGS. 3A, 3B, 3C, 4, 5, 6, and 7, it can be shown that the distribution of compressed air and the interaction of the movable components at the beginning of the forward stroke is identical in both modes of operation. As it is mentioned above, during the forward stroke of striker assembly 150, the air pressure in rear chamber 212 gradually drops. In the retracting mode of operation the difference between the levels of nominal (high) and reduced (low) pressure is significantly smaller than in the regular mode of operation, and the level of pressure in rear chamber 212 becomes lower than in reduced (low) pressure line much before striker assembly 150 complete its forward stroke. And as soon as the level of the pressure in rear chamber 212 drops below the level of the pressure in the reduced (low) pressure line, control valve 132 moves to its extreme right position and cuts off the supply of compressed air to rear chamber 212 which becomes to be open to the atmosphere through the same passages as in the regular mode of operation. At the same time the compressed air at the reduced (low) pressure through the same passages as in the regular mode of operation enters into front chamber 251, slows down striker assembly 150 preventing it from imparting a blow to tool 183, and is forcing striker assembly 150 to begin its backward stroke. The functioning of exhaust valve assembly 160 in both modes of operation is also similar. At the end of its backward stroke, striker assembly 150 imparts a blow to the right (front) end of air control valve chest 131 in spite of the air cushion in rear chamber 212, since the air pressure in front chamber 251 during the backward stroke at the retracting mode of operation is essentially higher than at the regular mode of operation. Similarly to the regular mode of operation, at the end of the backward stroke, striker assembly 150 with its tail part 181 pushes air control valve 132 to its extreme left (rear) position and the forward stroke of a new cycle begins.

### B. Formulas for Calculating the Optimal Values of the Length of the Striker and its Stroke

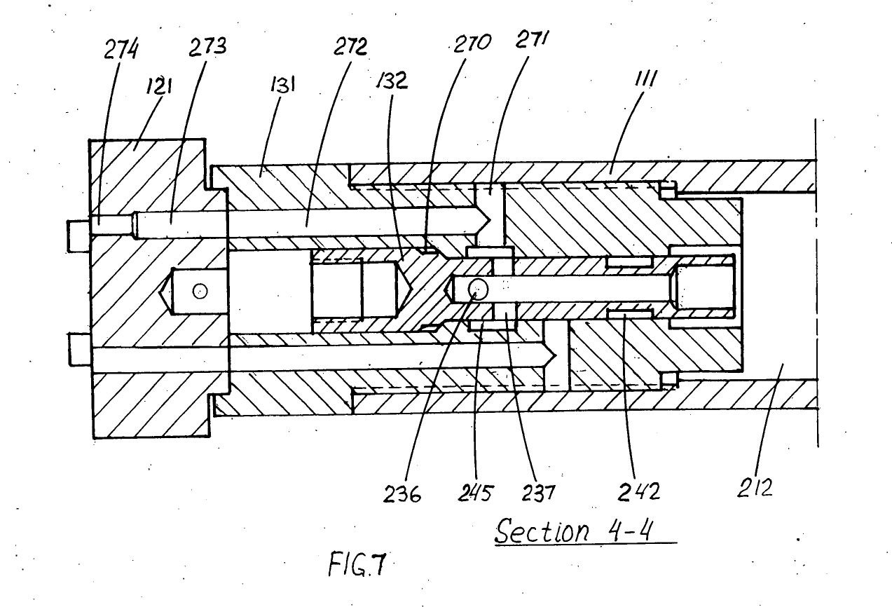

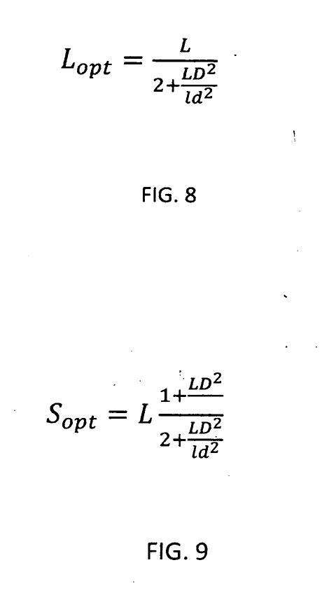

As it was mentioned above, the author of the current invention performed the appropriate analytical investigations of the working process of a pneumatic hammer with the goal to determine the optimal values of the lengths of the striker and its stroke with respect to maximum kinetic energy that the tool will possess after the blow of the striker. This investigation allowed obtaining mathematical formulas for calculating the optimal length of the striker and its forward stroke. These formulas are respectively presented in FIGS. 8 and 9, where:

Lₒₚₜ is the optimal value of the length of the striker,
Sₒₚₜ is the optimal value of the length of the forward stroke of the striker during the regular mode of operation,
L is the effective length of the tubular housing of the hammer that is equal to the distance between the limits in which the striker reciprocates (actually, the effective length of the tubular housing represents a part of this housing in which the striker reciprocates and it is equal to the sum of the length of the striker and the length of its forward stroke),
D is the diameter of the striker,
d is the diameter of the tool,
l is the length of the tool.

What is claimed is:

1. An optimized pneumatic hammer characterized by the maximum kinetic energy of its tool and by the ability of working in a regular mode of operation during which said tool interacts with the target media or in a retracting mode of operation during which said tool is released from being jammed by the media and comprising:
a tubular housing assembly including a tubular housing that accommodates the basic assemblies and components of said optimized pneumatic hammer, a rigidly attached to the lateral surface of said tubular housing longitudinal structural shape creating a longitudinal air passage allowing the compressed air to communicate between the rear and front ends of said tubular housing, and means for handling said optimized pneumatic hammer by an operator or mechanical arm;
an air control valve chest assembly including an air control valve chest rigidly secured into the rear end of said tubular housing and having air passages allowing the compressed air that is needed for the operation of said optimized hammer to flow into said tubular housing and to escape to the atmosphere, a double stepped air control valve that cyclically reciprocates inside of said air control valve chest directing the flows of the compressed air causing the operation of said optimized pneumatic hammer;
a tool holder assembly including a tool holder housing rigidly secured to the front end of said tubular housing, a leading bushing accommodated by said tool holder housing, a tool movably inserted into said leading bushing, a spring holding sleeve securely attached to said tool holder housing, and a coil spring accommodated by said spring holding sleeve enabling said coil spring to push constantly said tool toward the rear of said tubular housing;
a striker assembly that under the pressure of the compressed air forces is cyclically reciprocating inside of said tubular hosing and including a striker, a pair of bushings on both ends of said striker which cyclically imparts heavy blows to said tool during the regular mode of operation or to the front part of said air control valve chest during the retracting mode of operation;
a compressed air flow splitter assembly including a splitter rigidly attached to the rear end of said air control valve chest, an air pressure regulator securely connected to said splitter that is connected with the source of compressed air for receiving a flow of compressed air at the nominal (high) pressure and splitting this flow into two lines of which one line representing the nominal (high) pressure line is directly connected with certain passages of said air control valve chest and said double step air control valve and is supplying compressed air for performing the forward stroke of said striker assembly while the other line is connected with said air pressure regulator that reduces the air pressure to the required level creating the reduced (low) pressure line that is connected with other passages of said air control valve chest and said double stepped air control valve and is supplying compressed air for performing the backward stroke of said striker assembly;
an exhaust valve assembly including an exhaust valve chest which is rigidly secured to the lateral surface of said tubular housing and having passages to communicate with the atmosphere and with the internal spaces of said tubular housing, and an exhaust valve that cyclically reciprocates inside said exhaust valve chest for opening exhaust passages to the atmosphere at the end of the forward stroke and to keep these passages closed during the backward stroke of said striker assembly.

2. An optimized pneumatic hammer of claim 1 wherein by adjusting the air pressure in said reduced (low) pressure line to appropriate levels said optimized pneumatic hammer is set to regular mode of operation or to retracting mode of operation.

3. An optimized pneumatic hammer of claim 1 wherein the length of said striker assembly is shorter than the length of its forward stroke during the regular mode of operation.

4. An optimized pneumatic hammer of claim 1 wherein during the entire backward stroke of said striker, said exhaust valve prevents said reduced (low) air pressure line from communicating with the atmosphere.
